(19) United States
(12) Patent Application Publication
(10) Pub. No.: US 2012/0032877 A1
(43) Pub. Date: Feb. 9, 2012

(54) Motion Driven Gestures For Customization In Augmented Reality Applications

(75) Inventors: Oliver Watkins, JR., Toronto (CA); Yousuf Chowdhary, Maple (CA); Jeffrey Brunet, Richmond Hill (CA); Ravinder "Ray" Sharma, Richmond Hill (CA)

(73) Assignee: XMG Studio, Toronto (CA)

(21) Appl. No.: 13/219,359

(22) Filed: Aug. 26, 2011

Related U.S. Application Data
(63) Continuation-in-part of application No. 13/102,815, filed on May 6, 2011.
(60) Provisional application No. 61/402,274, filed on Aug. 27, 2010.
(60) Provisional application No. 61/401,149, filed on Aug. 9, 2010.

(51) Int. Cl. G06F 3/01

(52) U.S. Cl. 345/156

(57) ABSTRACT

A motion-driven user interface for mobile device-based augmented reality applications is described which provides a user with the ability to execute user interface input commands by physically manipulating the mobile device in space. The mobile device uses embedded sensors to identify the type and extent of the manipulation which cause execution of a corresponding user interface input command which can vary depending upon the operating context of the mobile device.

### CROSS-REFERENCE TO RELATED APPLICATIONS

This application claims the benefit of U.S. Provisional Patent Application No. 61/402,274 filed on Aug. 27, 2010 and entitled “Methods and Systems for Motion Driven Gestures for Customization in Augmented Reality Applications,” and is a continuation-in-part of U.S. patent application Ser. No. 13/102,815 filed on May 6, 2011 and entitled “Motion Driven User interface,” which itself claims priority to U.S. Provisional Patent Application No. 61/401,149 filed on Aug. 9, 2010 and entitled “Motion Driven User Interface,” all of which are incorporated herein by reference in their entirety.

### BACKGROUND OF THE INVENTION

1. Field of the Invention

The present invention relates generally to user interfaces for humans to interact with electronic devices, particularly those electronic devices that are mobile, in augmented reality applications.

2. Description of the Prior Art

A user interface facilitates the interaction between an electronic device such as a computer and a user by enhancing the user's ability to utilize application programs running on the device. The traditional interface between a human user and a typical personal computer is implemented with graphical displays and is generally referred to as a graphical user interface (GUI). Input to the computer or particular application program is accomplished by a user interacting with graphical information presented on the computer screen using a keyboard and/or mouse, trackball or other similar input device. Such graphical information can be in the form of displayed icons or can simply be displayed text in the form of menus, dialog boxes, folder contents and hierarchies, etc.

Some systems also utilize touch screen implementations of a graphical user interface whereby the user touches a designated area of a screen to affect the desired input. Some touch screen user interfaces, for example the one implemented in the iPhone mobile device made by Apple Inc. of Cupertino, Calif., use what is known as “finger-gestures.” Below is an exemplary list of such finger gestures and the associated commands they cause to be executed:
Double-Tap: A quick double-tap of a user's finger on the device screen: in the Safari web browser distributed by Apple Inc., performing a double-tab on a username/password field on a displayed web-page will zoom-in on that portion of the page and also display the device's on-screen keyboard to assist a user in filling in the form fields. Similarly, a double-tap on the display screen when a video is displayed will zoom-in or enlarge the displayed video while a second double-tap will restore or zoom-out the displayed video to its originally displayed view size.
Drag: While reading an email or viewing the contents of a web-page, a user can slowly drag a finger across the display screen either horizontally or vertically to scroll displayed text on-screen in the chosen direction.
Flick: A flick is similar to a drag except a user moves their finger across the display screen faster than with a drag gesture and then the user lifts their finger off the displayed screen at the end of the drag motion. This causes a faster scroll of the displayed view in the chosen direction than with a drag gesture and one which may continue for a short period of time after the user has lifted their finger from the display screen.
Pinch: A user can employ a two-finger pinch action across the display screen to zoom out of a particular area of the screen. To perform a pinch, a user places two fingers on the display screen and squeezes the fingers together to zoom out and spreads them apart to zoom in.
Delete: Using a flick gesture on the display screen in a horizontal direction over a displayed item such as a video, song or email provides a way for a user to delete the item. Performing a flick gesture causes the device to display a red “delete” button on the display screen which the user can then tap to signal to the device to delete the item. Typically such delete operations then generate a dialog box requesting a user confirm the requested delete operation by tapping a confirmation button before the device actually performs the delete operation. In this way, if a user has a change of mind, they can simply tap a cancel button or tap anywhere other than on the red delete button to cancel the action.

Referring now to FIG. 1, a prior art mobile device touch screen user interface will now be described. Shown as an exemplary mobile device 101 is the iPhone from Apple Inc. positioned or held sideways by a user in a landscape mode (rather than in an upright or portrait mode). Mobile device 101 has a screen display 103 which in this example has a slideshow series of images 103, 104, 105, 106, 107 and 108 displayed thereon. Mobile device 101 also has a traditional touch screen graphical user interface element known as a slider bar 107 displayed on display 103. Slider bar 107 includes a displayed sliding element 109 which a user can touch and using the drag command can move sliding element 109 back and forth along slider bar 107. In this example, a user doing so causes the slideshow series of images 103, 104, 105, 106, 107 and 108 to cycle back and forth by, for example, changing from displaying image 105 to displaying image 104 as the user drags sliding element 109 of slider bar 107 to the left and then changing back to displaying image 105 when the user drags sliding element 109 of slider bar 107 back to the right and then changing from displaying image 105 to displaying image 106 as the user continues to drag sliding element 109 of slider bar 107 to the right.

In a similar fashion, mobile device 101 may also have a traditional touch screen graphical user interface where, rather than using slider bar 107 with sliding element 109 to effect moving between images 103, 104, 105, 106, 107 and 108, instead the user simply touches the displayed images themselves and again using the drag command cycles through them.

There are, however, many applications where the user interfaces discussed above are impractical or inefficient. Having to use a separate input device such as a mouse to interact with a GUI becomes inconvenient when that means carrying both a mobile device and a mouse device and further requires the use of two hands, one to hold the mobile device and one to operate the mouse device. This later limitation likewise exists in the case of traditional touch screen user interfaces deployed on mobile devices. These limitations of the prior art are overcome by providing a motion driven user interface for mobile devices as described herein.

Modern gaming applications are one category of computing programs for which the prior art user interfaces discussed above are particularly problematic. Though a fairly recent advent, video games (e.g., Starcraft) have become increasingly popular over the past few decades and have consistently pushed the envelope for graphical technologies, memory capacity, and general computing. It is no surprise then, that video games have crossed into other non-digitally mediated games such as tabletop card games or sports, or even mobile devices where games were not previously present.

Early attempts to create mixed mediated games (i.e., those crossing non-digital and digital mediums) were prompted by what is known in the industry as the ‘Holodeck.’ The term refers to a fictional technology (featured in the Star Trek television and movie universe) allowing users within a particular room to create an entirely simulated environment all around them. This Holodeck inspired many to try to create similar immersive simulated experiences, and is largely responsible for the rise of Virtual Reality games in the late 1990s. These games could be considered a trivial form of mixed mediated games because they cross a non-digital medium (the player's natural, real-world movements) and the digital medium of the simulated game world. Requiring special goggles, gloves, or other peripherals to properly experience the simulated reality, these games often had clunky interfaces with limited gameplay interactions. Given the high expectations for Virtual Reality, these games failed to deliver on their promise of truly immersive simulated experiences.

Today, the Holodeck is considered the Holy Grail of immersive gaming experiences—a tantalizing but unattainable goal. In light of this, many game developers have refocused their efforts on more practical techniques to create immersive experiences. The initial insight was: “Why simulate a virtual reality when you can just use what's already in the real world?” The second insight was: “If we leverage the real world as much as possible, can we simply add virtual elements as needed to enrich that experience?” These insights gave rise to true mixed mediated games, or augmented reality (AR) games.

AR systems use video cameras and other sensor modalities to reconstruct a mixed world that is both real and virtual by blending virtual images generated by a computer with a real image viewed by a user. To do this, the AR application controller acquires image data representing real world objects an image taken from a camera), converts this data into virtual world compatible data, and superimposes the converted data into the virtual world environment.

Other applications of AR rely on superimposing location-based virtual images over the real-world camera feed. This confluence of the virtual simulation and real life is an essential part of any augmented reality experience.

Traditional GUI implementations of level design tools for AR environments are generally implemented in a personal computer (PC) environment. But applications targeted towards customization for level building in AR environments can be stow and cumbersome to use on PC platforms because menus in a GUI are typically hierarchical and commands for finer customization can be easily buried 3 to 4 layers deep. Inputs from the user, moreover, are traditionally discrete, one-dimensional motions where each motion operates within either a real-world or virtual-world context and only broadly applies to digital objects within that world (e.g., augmented global positioning system (aGPS) positions only broadly reflect the walkable areas of an AR environment). And, AR implementations designed on a PC necessarily divorce commonly-used metaphors (e.g., “baking” an AR level) from the series of inputs required to initiate that process, thereby making AR design less intuitive than desired.

A motion-driven user interface for AR design in mobile devices as described herein overcomes the limitations of the prior art.

### SUMMARY

In one example is a mobile device user interface method comprising: detecting motion of the mobile device using one or more sensors located within the mobile device; confirming by a processor of the mobile device that the detected motion of the mobile device exceeds a preset threshold; determining by the mobile device processor that the confirmed detected motion of the mobile device matches a defined type of motion; and executing by the mobile device processor a user interface input command associated with the defined type of motion.

In a further example of the mobile device user interface method, the user interface input command associated with the defined type of motion varies depending upon what context in which the mobile device user interface is operating when the step of detecting motion of the mobile device occurs.

In another example is a non-transitory computer readable medium containing programming code executable by a processor, the programming code configured to perform mobile device user interface method, the method comprising: detecting motion of the mobile device using one or more sensors located within the mobile device; confirming by a processor of the mobile device that the detected motion of the mobile device exceeds a preset threshold; determining by the mobile device processor that the confirmed detected motion of the mobile device matches a defined type of motion; and executing by the mobile device processor a user interface input command associated with the defined type of motion.

In one example is a motion-driven user interface method for the customization of AR environments comprising: detecting a sequence of discrete motions of a mobile device using one or more sensors located within the mobile device, each of the discrete motions having a type and an extent; confirming by a processor of the mobile device that the detected sequence of discrete motions of the mobile device exceeds a preset threshold; determining by the mobile device processor that the types of the discrete motions in the confirmed detected sequence of discrete motions of the mobile device matches a defined sequence of discrete motions; and executing by the mobile device processor a motion-driven user interface input-command associated with the defined sequence of discrete motions, wherein the input command customizes an AR environment based on the extent of the discrete motions.

In a further example of the motion-driven user interface method, the user interface input command associated with the defined sequence of discrete motions varies depending upon what context in which the motion-driven user interface is operating when the step of detecting sequence of discrete motions of the mobile device occurs.

In another example is a non-transitory computer readable medium having stored thereupon a programming code executable by a processor, the programming code configured to perform a motion-driven user interface method for the customization of AR environments, the method comprising: detecting a sequence of discrete motions of a mobile device using one or more sensors located within the mobile device, each of the discrete motions having a type and an extent; confirming by a processor of the mobile device that the detected sequence of discrete motions of the mobile device exceeds a preset threshold; determining by the mobile device processor that the types of the discrete motions in the confirmed detected sequence of discrete motions of the mobile device matches a defined sequence of discrete motions; and executing by the mobile device processor a motion-driven user interface input-command associated with the defined sequence of discrete motions, wherein the input command customizes an AR environment based on the extent of the discrete motions.

### BRIEF DESCRIPTION OF DRAWINGS

FIG. 1 depicts a prior art mobile device touch screen user interface.

FIG. 2 an exemplary process flowchart of one embodiment.

FIG. 3 is a diagram of various possible physical motions of a mobile device according to one embodiment.

FIG. 4 is an example of linear motion of a mobile device along an x-axis causing execution of a user interface input command according to one embodiment.

FIG. 5 is an example of linear motion of a mobile device along a y-axis causing execution of a user interface input command according to one embodiment.

FIG. 6 is an example of linear motion of a mobile device along a z-axis causing execution of a user interface input command according to one embodiment.

FIG. 7 is an example of angular motion of a mobile device about the causing execution of a user interface input command in a first operating context according to one embodiment.

FIG. 8 is another example of angular motion of a mobile device about the y-axis causing execution of a user interface input command in a second operating context according to one embodiment.

FIG. 9 is an example of a composite motion of a mobile device about the z-axis causing execution of a user interface input command according to one embodiment.

FIG. 10 is an example of a transformative motion of a mobile device causing execution of a user interface input command according to one embodiment.

FIG. 11 is an example of a deformative motion of a mobile device causing execution of a user interface input command according to one embodiment.

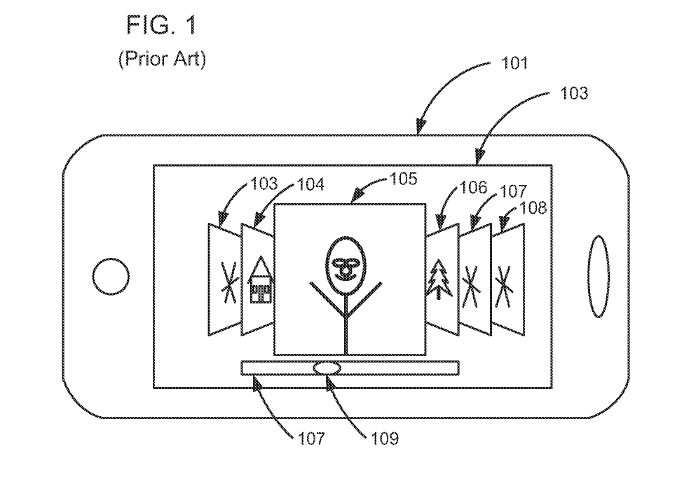

### DETAILED DESCRIPTION OF THE INVENTION

In various embodiments are provided methods and systems for a motion driven context sensitive user interface for mobile devices. In one embodiment the method provides a user with the option to cause execution of certain user interface input commands by physically moving the mobile device in space. This provides a user with the convenience of interacting with the mobile device using embedded sensors in the mobile device. By gathering and processing data from multiple sensors within the mobile device, certain commands can be executed that in the past required a traditional user interface such as a graphical user interface.

As portable electronic devices become more compact, and the number of functions performed by a given device increase, it has become a significant advantage to use these portable devices for functions other than the ones they were originally designed for. Some mobile devices like the iPhone whose main function may be considered to be primarily a phone can also be used for gaming as they provide enough computing power, incorporate a touch screen interface and have embedded sensors like global positioning system (GPS), camera, compass, gyroscope and accelerometer. Such devices are ripe for a shift in the way user interfaces are implemented. Taking advantage of these embedded sensors, a motion driven user interface is disclosed herein. Thus by moving the device in space certain commands can be executed as will be described.

As has been discussed, menu driven GUIs are tedious and often require the use of both hands (e.g., one hand to hold the device and the other to control an external input device or touch the screen). However, using the approach described herein, certain motions are natural and can be easily performed with one hand which is holding the mobile device, thus giving the user the freedom to do other tasks with the spare hand, while still meaningfully interacting with the mobile device.

The present disclosure describes a motion driven user interface as a method and a system that uses the output of multiple sensors available in a mobile device to capture the motion and then performing a command/task associated with that particular motion.

Various sensors available on mobile devices are briefly discussed below:
Digital Compass. An electro-magnetic device that detects the magnitude and direction of the earth's magnetic field and point to the earth's magnetic north. Used to determine initial state, and then to determine ground-plane orientation during use/play.
Accelerometer. Used for corroborating the compass when possible, and for determining the up-down plane orientation during use/play. In an augmented reality (AR) game compass and accelerometer provide directionality information.
Gyroscope. A gyroscope is a device for measuring or maintaining orientation, based on the principles of conservation of angular momentum. Gyroscopes can be mechanical or based on other operating principles, such as the electronic, microchip-packaged micro-electro-mechanical systems (MEMS) gyroscope devices found in consumer electronic devices. Gyroscopes are used for navigation when magnetic compasses do not work, or for stabilization, or to maintain direction.

This application discloses methods and systems that use one or more of the above listed embedded sensors in a mobile device to implement a motion driven user interface to further enhance the user experience.

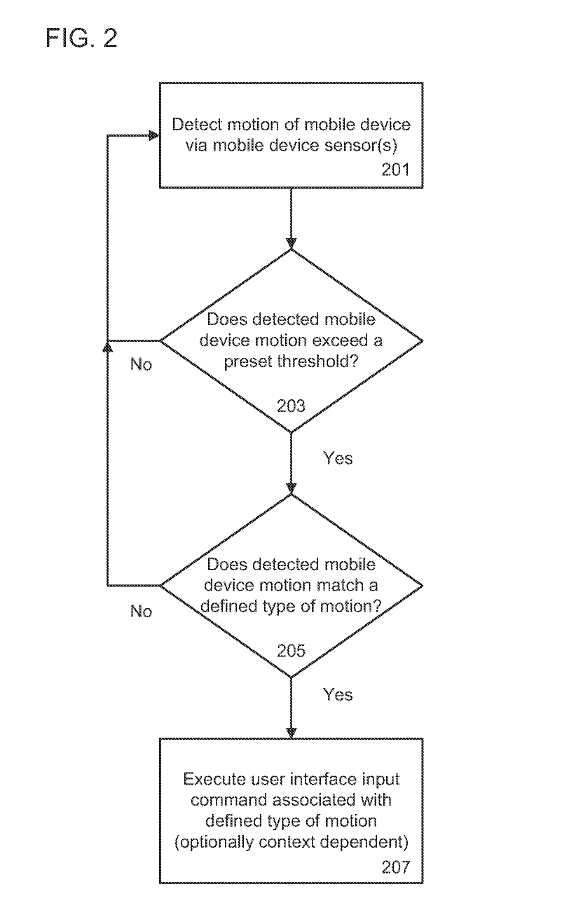

Referring now to FIG. 2, an exemplary process flowchart of one embodiment can be seen. In step 201, a user's physical movement or motion of the mobile device is detected by the mobile device using one or more sensors located within the mobile device. In step 203, it is determined whether the detected motion exceeds a preset threshold which differentiates between intended motions caused by the user from those that may be un-intended and instead caused by the normal movement of the user for example while walking. If the detected motion does not exceed the preset threshold in step 203 then the process returns to step 201. Alternatively, if the detected motion does exceed the preset threshold in step 203 then, in step 205, it is determined whether the detected mobile device motion matches a defined type of motion. If the detected motion does not match a defined type of motion in step 205 then the process returns to step 201. Alternatively, if the detected motion does match a defined type of motion in step 205 then a user interface input command associated with the defined type of motion is executed by the mobile device in step 207.

In various embodiments the operations and processing described are handled by a processor of the mobile device running software stored on the mobile device stored in memory of the mobile device.

While any such defined type of motion may be used, in one embodiment these motions are typically either a linear motion, an angular motion or a composite motion (it is to be understood that a composite motion is a combination of more than one linear motion, a combination of more than one angular motion or a combination of at least one linear motion and at least one angular motion) as will be explained.

In this way the mobile device, using its sensors, can measure and calculate a range of motions that can then be translated to commands that are context-specific, i.e., the command is different depending upon the operating context of the mobile device. As such, in some embodiments, the user interface input command associated with the defined type of motion is dependent upon what context the mobile device is operating in at the time motion of the mobile device is detected in step 201 as will be explained.

To be clear, an operating context is the current user interface operational mode or state of the mobile device which in various examples is when the mobile device is displaying to the user one application's GUI versus displaying to the user a different application's GUI, or when the mobile device is displaying to the user an application's GUI when running one part or function of the application versus displaying to the user that application's GUI when running a different part or function of the same application, or when the mobile device is displaying to the user an application GUI versus displaying to the user an operating system function GUI. It is to be understood that operating context can vary by part or function of an application, by part or function of one application versus part or function of a different application, or by part or function of an operating system and can also vary depending upon particular hardware components of the mobile device (e.g., what sensors are included in the mobile device, what other user interface input devices are included in or coupled to the mobile device, etc.).

In various embodiments, the association between a defined type of motion and its user interface input command is mapped in a table, or may use a database or a file for such mapping. The mapping may vary from one context to another. For example when playing an AR game, game related motions may be applicable. Alternatively, the mapping may change as the user progresses from one level of the game to another. Exemplary defined types of motions and associated user interface input commands are shown in Table 1 below which also shows examples of different commands which may be executed dependent upon the operating context of the mobile device when the device motion occurs. As an example, the “Enter” key is included in the table as an example command for a quick angular motion about the x-axis, but “continue” might be the proper name for this command in one context of a given GUI.

TABLE 1
Examples of Linear, Angular, and Composite Motions

| Motion | Command |
|---|---|
| Linear motion along x-axis (move right) | pan right, play slideshow/video, roll forward in |
| | a radial view |
| Linear motion along x-axis (move left) | pan left, pause slideshow/video, roll back in a |
| | radial view |
| Linear motion along y-axis (move up) | pan up, maximize view, move to higher level in |
| | folder hierarchy |
| Linear motion along y-axis (move down) | pan down, minimize view, move to lower level |
| | in folder hierarchy |
| Linear motion along z-axis (move in/forwards) | zoom in |
| Linear motion along z-axis (move | zoom out |
| out/backwards) | |
| Quick linear motion along x-axis (double move | repeat previous action, fast forward |
| right aka fast jab right) | slideshow/video |
| Quick linear motion along x-axis (double move | undo previous action, rewind slideshow/video |
| left aka fast jab left) | |
| Repeated linear motion along x-axis (repeated | scramble, reorganize, horizontal sort, |
| back and forth motion aka sideways shake) | disapprove |
| Quick linear motion along y-axis (double move | jump, scroll up or page up, move to top of |
| up aka fast jab up) | folder hierarchy |
| Quick linear motion along y-axis (double move | duck, scroll down or page down, move to |
| down aka fast jab down) | bottom of folder hierarchy |
| Repeated linear motion along y-axis (repeated | charge weapon, flip, vertical sort |
| up and down motion) | |
| Quick linear motion along z-axis (double move | push, knock down, knock out, approve |
| in aka fast jab forwards) | |
| Quick linear motion along z-axis (double move | grab & pull, tug, or yank |
| out aka fast jab backwards) | |
| Repeated linear motion along z-axis (repeated | wake up device, end process, jolt game |
| in and out motion) | opponent |
| Angular motion about an x-axis (roll/tilt | Accelerate forward |
| back/pitch back) | |
| Angular motion about an x-axis (roll/tilt | Decelerate/brake |
| forward/pitch forward) | |
| Quick angular motion about an x-axis (quick | Continue/go/Enter key |
| roll/tilt back/pitch back) | |
| Quick angular motion about an x-axis (quick | Return/Backspace key/Escape key |
| roll/tilt forward/pitch forward) | |
| Repeated angular motion about an x-axis | Winding/reeling |
| (repeated roll/tilt back/pitch back) | |
| Repeated angular motion about an x-axis | Unwinding/unreeling |
| (repeated roll/tilt forward/pitch forward) | |
| Angular motion about a y-axis (pivot/turn | Cycle forward through photo |
| clockwise/yaw clockwise) | album/slideshow, open/close door in a game |
| Angular motion about a y-axis (pivot/turn | Cycle backward through photo |
| counterclockwise/yaw counterclockwise) | album/slideshow, open/close door in a game |
| Angular motion about a z-axis (rotate/tilt | Make a right turn |
| right/roll clockwise) | |
| Angular motion about a z-axis (rotate/tilt | Make a left turn |
| left/roll counterclockwise) | |
| Repeated angular motion about a y-axis | vacuum effect |
| (double yaw clockwise) | |
| Repeated angular motion about a y-axis | Blowing fan effect |
| (double yaw counterclockwise) | |
| Quick angular motion about a z-axis (quick roll | Send to front |
| clockwise) | |
| Quick angular motion about a z-axis (quick roll | Send to back |
| counterclockwise) | |
| Repeated angular motion about a z-axis | Polish/shine/buff surface |
| (double roll clockwise) | |
| Repeated angular motion about a z-axis | Erase |
| (double roll counterclockwise) | |
| Repeated back and forth angular motion or | Stabilize drifting car |
| forth and back angular motion about a z-axis | |
| (counterclockwise and clockwise or clockwise | |
| and counterclockwise) | |
| Composite linear motion along y-axis and x- | Frame or crop an image |
| axis (up., right, down and left) | |
| Composite angular motion about an x-axis and | Hinge/weld/tie objects at point |
| angular motion about a z-axis | |
| (tilt and rotate around corner) | |
| Composite linear motion along a z-axis (push | Select center most object in view |
| out) and angular motion about a z-axis | |
| (clockwise or counter-clockwise rotation) | |
| Composite linear motion along z-axis (move | Tunneling in/boring in/screwing in/causing |
| in/forwards) and angular motion about a z-axis | clockwise turbulence |
| (rotate/tilt right/roll clockwise) | |
| Composite linear motion along z-axis (move | Tunneling out/boring out/unscrewing/causing |
| out/backwards) and angular motion about a z- | counterclockwise turbulence |
| axis (rotate/tilt left/roll counterclockwise) | |

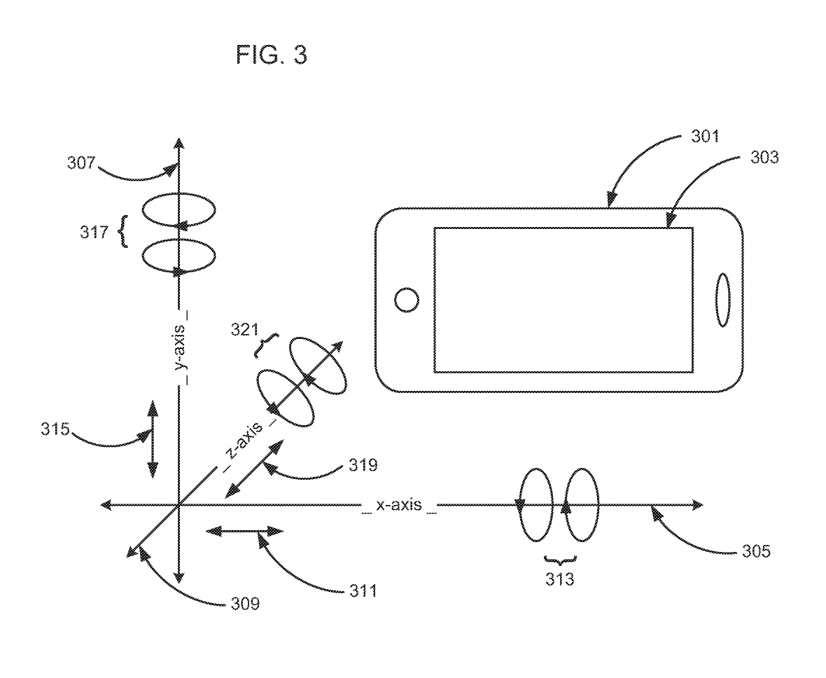

Referring now to FIG. 3, again according to one embodiment, various defined motions will now be explained. A mobile device 301, which again may be an iPhone mobile device from Apple, Inc., is shown positioned in a landscape mode and having a display screen 303. The positioning of mobile device 301 is also shown corresponding to three orthogonal axes shown and labeled as an “x-axis” 305 paralleling the bottom or tong dimension of mobile device 301 in a landscape position, a “y-axis” 307 paralleling the edge/side or short dimension of mobile device 301 in a landscape position, and a “z-axis” 309 perpendicular to screen 303 or the front face of mobile device 301. As will now be explained, a user can move mobile device 301 relative to these axes in various fashions.

Mobile device 301 can be moved laterally (left to right or right to left in the figure) along x-axis 305 as indicated by movement arrow 311 in the figure. Mobile device 301 can likewise be moved longitudinally (up or down in the figure) along y-axis 307 as indicated by movement arrow 315 in the figure. Mobile device 301 can also be moved in or out of the figure along z-axis 309 as indicated by the movement arrow 319 in the figure. These are the linear motions of mobile device 301.

Mobile device 301 can be moved in a clockwise or counterclockwise fashion (rotated) about x-axis 305 as indicated by a pair of rotation arrows 313 in the figure. Mobile device 301 can likewise be moved in a clockwise or counterclockwise fashion (rotated) about y-axis 307 as indicated by a pair of rotation arrows 317 in the figure. Mobile device 301 can also be moved in a clockwise or counterclockwise fashion (rotated) about z-axis 309 as indicated by a pair of rotation arrows 319 in the figure. These are the angular motions of mobile device 301.

Mobile device 301 can also be moved via a combination of the linear motions, the angular motions or both, as previously stated. These are the composite motions of mobile device 301.

It is to be understood that although the intersection of the three axes, namely x-axis 305, y-axis 307 and z-axis 309, commonly referred to as an origin, is shown as being located some distance from mobile device 301 in the figure, this was merely done for visually clarity in the figure and therefore need not be the case in any given situation. Thus, the origin may be located at any point in space relative to mobile device 301 including touching or even within mobile device 301. Therefore, any discussion herein regarding mobile device movement with respect to the three axes (whether linear, angular or composite) is likewise understood to cover any placement of the origin and the three axes relative to mobile device 301. For example, discussion herein of angular motion of mobile device 301 about y-axis 307 can mean that mobile device 301 starts from a position some distance along x-axis 305 and therefore all of mobile device 301 is moving around y-axis 307 (in which case all of mobile device 301 is moving through space) or can mean that a left edge of mobile device 301 starts from a position no distance along x-axis 305 (in which case the left edge of mobile device 301 is coincident with y-axis 307) and therefore the rest of mobile device 301 is moving around y-axis 307 white the left edge of mobile device 301 stays stationary (in which case mobile device 301 is pivoting about its left edge), or can mean that some part of mobile device 301 starts from a position some negative distance along x-axis 305 and therefore the rest of mobile device 301 on either side of that part of mobile device 301 is moving around y-axis 307 while that part of mobile device 301 stays stationary (in which case mobile device 301 is essentially stationary while rotating in space).

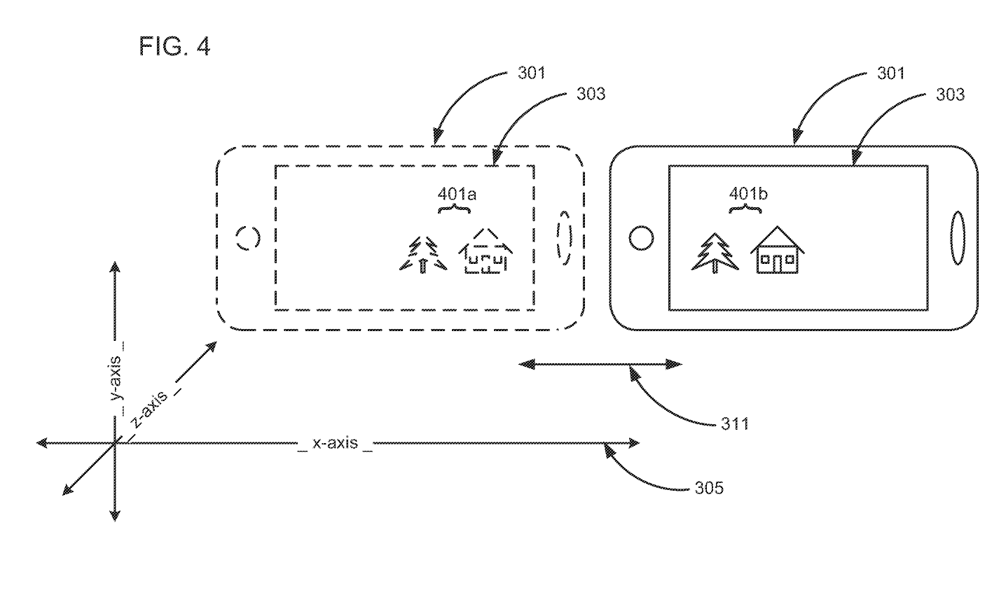

Referring now to FIG. 4, examples of linear motion along x-axis 305 will now be described. Mobile device 301 is shown being moved sideways by a user laterally from left to right (and can also be moved laterally in the opposite direction, that is, from right to left) along x-axis 305 as indicated by movement arrow 311 in the figure. Mobile device 301 is shown having a display screen 303 on which is displayed a scene 401a of a tree and a house before being moved sideways by a user laterally from left to right along x-axis 305 which then appears as scene 401b of the same tree and house after being moved. In the operating context of mobile device 301 when this lateral movement along x-axis 305 occurred, as can be seen in the figure, an associated user interface input command is executed to move the tree and house of scene 401a laterally across display screen 303 of mobile device 301 to become scene 401b due to the user having moved mobile device 301 from left to right along x-axis 305.

This is accomplished because a user's movement of mobile device 301 is detected by sensors within the mobile device such as a gyroscope and an accelerometer which sensors inform the mobile device when the user starts and stops the motion. When the mobile device detects that a motion has started, it can then continue to track changes in the X, Y, or Z coordinates of the mobile device's position for changes until it detects that the motion has stopped. If the mobile device calculates a net change with respect to an initial stationery position in coordinates along x-axis 305, e.g., from a smaller value to a larger value, and it does not measure any appreciable changes in coordinates along either of y-axis 307 or z-axis 309 (for example, a preset threshold of a change in magnitude less than 10% of either y-axis 307 or z-axis 309 of the magnitude of the delta vector in x-axis 305), then the mobile device can conclude that the user performed an intentional left-to-right lateral motion with the device. Of course, the preset threshold can be definable and may vary from one instance to the other depending on implementation and operating context.

Of course, if the operating context were different, for example if a video was paused on display screen 303 of mobile device 301 when the lateral movement occurred, some other associated user interface input command would execute, for example, to play the video. Likewise, if mobile device 301 is then moved back laterally to the left then an associated user interface input command of pausing the video would be executed.

In a further embodiment, the speed with which the mobile device is moved, again as sensed via sensors within the mobile device, can also be used to determine a defined type of motion. For example, a quick lateral movement to the right can be a defined type of motion such that if the mobile device is so moved when playing a video on the display screen this can cause a fast-forward user interface input command to be executed. Likewise a quick lateral movement to the left can be a defined type of motion such that if the mobile device is so moved when playing a video on the display screen this can cause a rewind user interface input command to be executed.

Numerous other examples are possible including moving a mobile device laterally towards the left with respect to an initial stationery position to cause execution of a user interface input command of panning left in a virtual world or rolling back a radial view, whereas a quick sideways or lateral ‘jab’ to the left can cause execution of a user interface input command to undo a previous action or rewind a video as has been explained. Likewise, moving the device towards the right with respect to an initial stationery position can cause execution of a user interface input command to pan right in a virtual world, roll forward in a radial view, or play a video—whereas a quick sideways or lateral ‘jab’ to the right might execute a user interface input command to fast forward the video or repeat or redo a previous action. Similarly, a ‘sideways shake’ motion where the user moves the mobile device laterally to the left and laterally to the right repeatedly might execute, depending on the context, a user interface input command to scramble, reorganize, or sort when a list view or other view which contains individually selectable elements is displayed on a display screen of the mobile device.

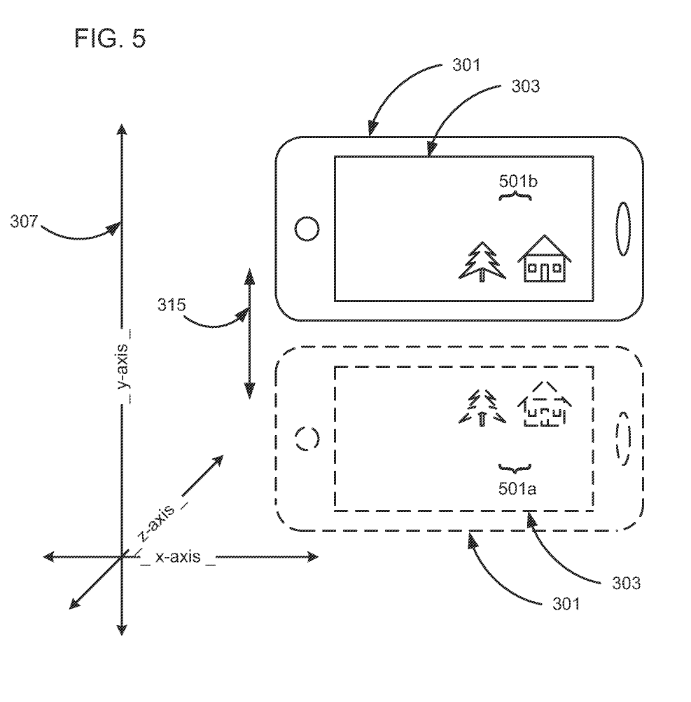

Referring now to FIG. 5, examples of linear motion along y-axis 307 will now be described. Mobile device 301 is shown being moved by a user up and down along y-axis 307 as indicated by movement arrow 315 in the figure. Mobile device 301 is shown having a display screen 303 on which is displayed a scene 501a of a tree and a house before being moved up by a user along y-axis 307 which then appears as scene 501b after being moved. In the operating context of mobile device 301 when this upward movement along y-axis 307 occurred, as can be seen in the figure, an associated user interface input command is executed to move the tree and house of scene 501a downwards across display screen 303 of mobile device 301 to become scene 501b due to the user having moved mobile device 301 upwards y-axis 307.

Again, this is accomplished because a user's movement of mobile device 301 is detected by sensors within the mobile device which sensors inform the mobile device when the user starts and stops the motion. In order to determine and calculate the up-down motions the mobile device compares the coordinate values along the y-axis with respect to an initial stationary position, while the coordinate values along the x-axis and z-axis remain relatively unchanged, i.e., less than some preset threshold. If the net difference between the initial position and a final position is positive (i.e. difference between coordinate values along the y-axis) then an upwards motion is indicated whereas a net negative change indicates a downwards motion.

Thus in one embodiment when a user moves the mobile device upwards with respect to the initial stationery position can cause execution of a user interface input command of panning the camera up in a virtual world or moving to a higher level in a folder hierarchy, whereas a quick ‘jab’ up motion can cause execution of a user interface input command to make the user's displayed avatar jump in that virtual world or move to the top of a folder hierarchy again depending upon implementation and operating context.

Likewise, the user moving the mobile device downwards with respect to the initial stationery position can cause execution of a user interface input command of panning the camera down in a virtual world or moving to a lower level in a folder hierarchy, whereas a quick ‘jab’ down motion can cause execution of a user interface input command to make the user's displayed avatar duck or slide in that virtual world or move to the bottom of a folder hierarchy.

Another possible example based on detected speed of a motion is a quick ‘up-down shake’ where the user quickly moves the mobile device up and down repeatedly which can cause execution of a user interface input command, depending on implementation and operating context, of charging a weapon in a game, making the user's displayed avatar flip through the air after a jump, or a vertical sort similar to how the horizontal or lateral quick sideways shake corresponds to a horizontal sort.

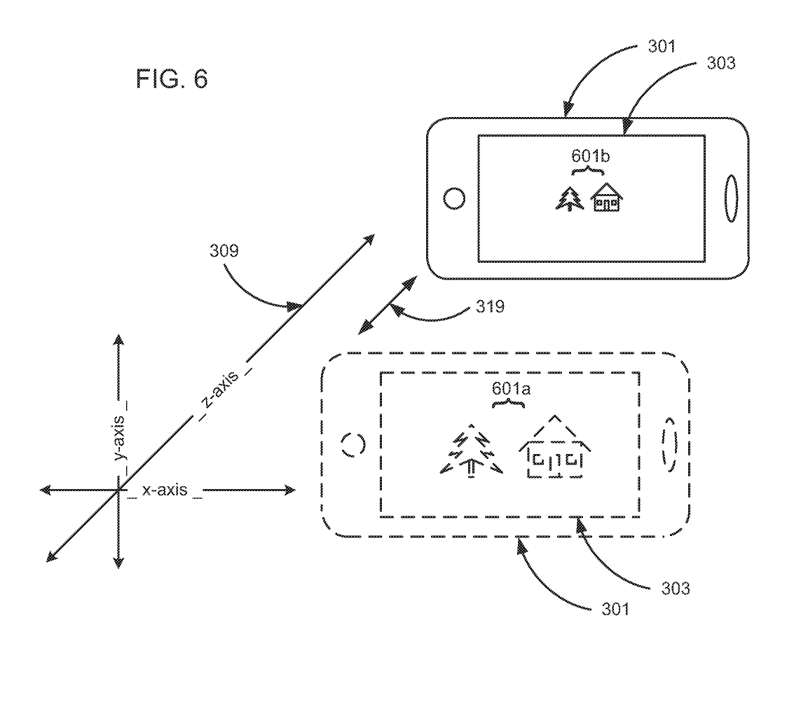

Referring now to FIG. 6, examples of linear motion along z-axis 309 will now be described. Mobile device 301 is shown being moved by a user in (forwards) and out (backwards) along z-axis 309 as indicated by movement arrow 319 in the figure. Mobile device 301 is shown having a display screen on which is displayed a scene 601a of a tree and a house before being moved out or backwards by a user along z-axis 309 which then appears as scene 601b after being moved. In the operating context of mobile device 301 when this backward movement along z-axis 309 occurred, as can be seen in the figure, an associated user interface input command is executed to zoom out the scene thus reducing the displayed size of the tree and house of the scene as shown in scene 601b.

Again, this is accomplished because a user's movement of mobile device 301 is detected by sensors within the mobile device such as a gyroscope and an accelerometer which sensors inform the mobile device when the user starts and stops the motion. In order to determine and calculate the in-out motions the mobile device compares coordinate values along the z-axis with respect to an initial position, while the coordinate values along the x-axis and y-axis remain relatively unchanged, i.e., less than some preset threshold. If the net difference between the initial position and a final position is positive (i.e., the difference between coordinate values along the z-axis) then an outwards or forward motion is indicated whereas a net negative change indicates an inwards or backward motion.

Thus in one embodiment when a user moves the mobile device away from the user with respect to the initial stationery position can cause execution of a user interface input command to zoom-out of a displayed scene. This zoom-out command can likewise occur in the operating context of a displayed AR image received from the output of a video capture device (e.g. a camera) of the mobile device where, by the user moving the mobile device away from themselves the AR image can be zoomed-out as shown in the figure.

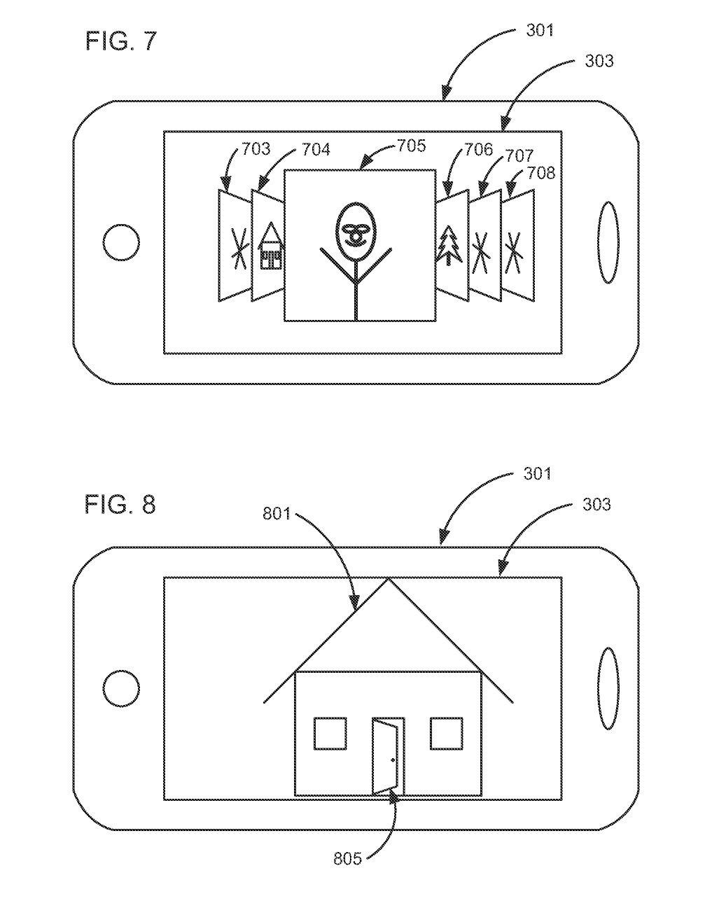

Referring now to FIG. 7, examples of angular motion about the y-axis will now be described. In these examples, mobile device 301 is moved by a user in an angular or rotational fashion about the y-axis as previously described. Mobile device 301 is shown having a display screen 303 on which is displayed a slideshow sequence of images 703, 704, 705, 706, 707 and 708. In the operating context of mobile device 301 when the user moves mobile device 301 in an angular backwards or counter-clockwise fashion about the y-axis causes execution of a user interface input command in mobile device 301 for the slideshow sequence of images to begin to play such that the slideshow transitions from having image 705 prominently displayed to having image 706 prominently displayed to then having image 707 be prominently displayed, etc. Likewise, when the user moves mobile device 301 in an angular forwards or clockwise fashion about the y-axis causes execution of a user interface input command in mobile device 301 for the slideshow sequence of images to pause such that a current prominently displayed image stays as the prominent displayed image or the slideshow sequence of images moves backwards from, for example, having image 706 prominently displayed to then having image 705 be prominently displayed depending upon implementation and operating context.

Again, this is accomplished because a user's movement of mobile device 301 is detected by sensors within the mobile device which sensors inform the mobile device of the motion or movement of the mobile device. Using these sensors the mobile device can determine, for example, that the right side of the device is rotating clockwise about the y-axis white the left side of the device has remained in a relatively constant position, i.e., less than some preset threshold. In this example, referring now to FIG. 8, this would indicate that the relative y-axis passes through the left side of mobile device 301, and thus the user is moving mobile device 301 as they would open a door to thereby cause a similar action in a graphical user interface of mobile device 301 in the operating context of a game or virtual world as is depicted in the figure where a house 801 with a door 805 is shown displayed on a display screen 303 of mobile device 301. In this example, a user interface input command to further open door 805 of house 801 can be caused to be executed by a user rotating mobile device 301 counterclockwise about its left edge and, conversely, a user interface input command to further close door 805 of house 801 can be caused to be executed by a user rotating mobile device 301 clockwise about its left edge.

Further, as has been explained, a user's movement of mobile device 301 can cause execution of a different user interface input command depending upon which operating context mobile device 301 is operating in when mobile device 301 detects that it has been moved by the user. For example, in the example shown with reference to FIG. 7 the operating context is that of a slideshow of images such that movement of the mobile device could cause execution of a first user interface input command as has been described whereas in the example shown with reference to FIG. 8 the operating context is that of a virtual world or game space such that movement of the mobile device could cause execution of a second user interface input command as has been described.

In one embodiment a preset threshold is defined to eliminate a possible margin of error (for example 10 angular degrees) within which the orientation of the left hand side of the mobile device could vary. Since the change in the right side of the device increased about the positive z-axis (and somewhat toward the negative X-axis) outside of the margin of error and the changes in the left side of the device were within the margin of error, the mobile device can then positively conclude that the user did rotate the right side of the device inward or forward.

Specifically, if the mobile device received linear position coordinates of the mobile device along the x-axis, y-axis and z-axis through the accelerometer, gyroscope, and/or other sensors from the sides of the device, then it would first transform these coordinates to a spherical coordinate system. As an example:
Let:
   phi=a tan 2(x, y)
   theta=a cos(z/r)
   r=sqrt(x̂2+ŷ2+ẑ2)
Then:
   phi on the left hand side of the device should be within the margin of error (<10% difference from its original value).
   phi on the right hand side of the device should be outside of the margin of error (>10% difference from its original value).
   theta and r should be within the margin of error

Again, this is accomplished because a user's movement of mobile device 301 is detected by sensors within the mobile device which sensors measure the acceleration and deceleration of the device, which sensors inform the mobile device when the user starts and stops the motion. When the mobile device detects that a motion has started, it can then continue to track changes in the phi, theta, or r coordinates of the device's polar position for changes until it detects that the motion has stopped. If the mobile device calculates a net change with respect to the initial stationery position in the value of right-side phi coordinates, e.g., from a negative value to a positive value, and it does not measure any appreciable changes in the coordinates of theta and r (for example a change in magnitude less than 10% of the magnitude of the delta vector in the two radii), then the system can conclude that the user performed an intentional rotation around the left edge motion with the device.

Thus in one embodiment when a user moves the right edge of the mobile device while the left edge stays relatively fixed with respect to the initial stationery position can cause execution of a user interface input command to cycle forward through a photo album, open or close a door in a displayed game, etc., depending upon implementation and operating context.

Likewise, moving the device from the left edge while the right edge stays relatively fixed, with respect to the initial stationery position can cause execution of a user interface input command to cycle backward through a photo album, open or close a door in a displayed game, etc., depending upon implementation and operating context.

Another possible example based on detected speed of motion is when the user quickly and repeatedly moves the mobile device back and forth along one edge while the other edge stays relatively stationary, which movement can cause execution of a user interface input command to simulate a vacuum or a fan-blowing effect where various adjustable displayed elements are ‘blown’ or ‘sucked’ to the waving side of the screen.

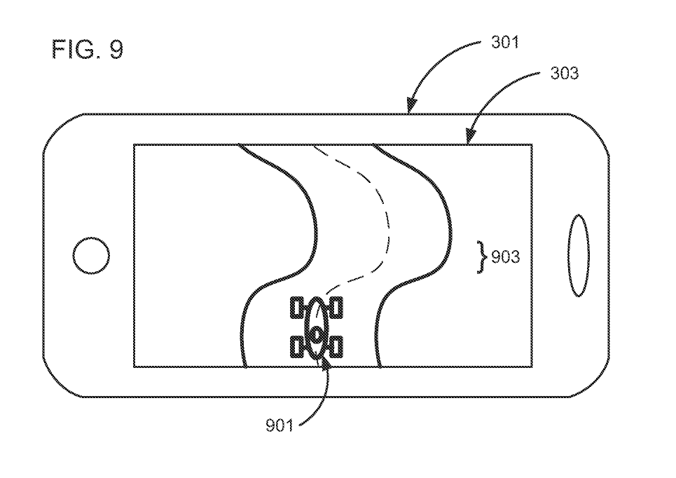

Referring now to FIG. 9, examples of angular motion about the z-axis will now be described. In these examples, mobile device 301 is moved by a user in an angular or rotational fashion about the z-axis as previously described. Mobile device 301 is shown having a display screen 303 on which is displayed a racing video game having an overhead view of a race car 901 on a racetrack 903. In the operating context of mobile device 301 when the user moves mobile device 301 in a rotational clockwise fashion about the z-axis causes execution of a user interface input command in mobile device 301 for the race car 901 to make a right turn and when the user moves mobile device 301 in a rotational counterclockwise fashion about the z-axis causes execution of a user interface input command in mobile device 301 to make a left turn. In this way a user of mobile device 301 playing the racing video game can steer race car 901 along racetrack 903 by simply rotating mobile device 301 clockwise and counterclockwise about the z-axis when mobile device is in the operating context of running the video game.

Thus in one embodiment when the user moves the mobile device in a clockwise direction about the z-axis as the center of rotation with respect to the initial stationery position can cause execution of a user interface input command to make a right turn, as when driving in the video game example. Similarly, a quick clockwise ‘toss’ angular motion about the z-axis can cause execution of a user interface input command to ‘send-to-back’ a top most view, as when shuffling cards, etc. Likewise, a user moving the device in a counterclockwise angular motion about the z-axis as the center of rotation with respect to the initial stationery position can cause execution of a user interface input command to make a left turn, as when driving in the video game example. Similarly, a quick counterclockwise ‘toss’ angular motion about the z-axis can cause execution of a user interface input command to ‘send-to-front’ a bottom most view, as when shuffling cards, etc. Still further, a repeated clockwise and counter-clockwise alternating rotation or angular motion about the z-axis can cause execution of a user interface input command to stabilize a drifting car in a racing game or to unlock a locked file provided the correct sequence of precise ‘twists’ or rotations are applied, as with a combination lock. Again, it is to be understood that each of these defined type of motions and their associated user interface input commands are dependent upon implementation and operating context.

In another example (not shown) of angular motion of a mobile device is a user's rotation or angular motion of the mobile device about the x-axis. By the user tipping top edge of the mobile device away from the user, with either the bottom edge remaining stationary or moving towards the user) in a rotational or angular direction about the x-axis with respect to an initial stationary position of the device can cause execution of a range of user interface input commands depending on implementation and operating context.

Thus in one embodiment a user tipping the top edge of the mobile device backwards (moving the top of the device away from the user with the X-axis as the center of rotation with respect to the initial stationery position) can cause execution of a user interface input command to accelerate forward, such as when pressing the gas pedal of a vehicle (e.g., race car 903 of FIG. 9), whereas a quick ‘flick forward’ rotational or angular motion about the x-axis can cause execution of a user interface input command to ‘continue’ or ‘go’, such as when a user presses a key on a keyboard to move forward or progress to a next view.

Likewise, a user tipping the bottom edge of the mobile device backwards (moving the bottom of the device away from the user with the X-axis as the center of rotation with respect to the initial stationery position) can cause execution of a user interface input command to press the brake pedal of a vehicle (e.g., race car 903 of FIG. 9), whereas a quick “flick backward” rotational or angular motion about the x-axis can cause execution of a user interface input command to ‘return’ or move ‘backward’, such as when a user presses a Backspace or Escape key on the keyboard to return, stop or backup to a previous view.

Further, in one embodiment when the user moves the mobile device in a rotational or angular motion repeatedly back and forth about the X-axis as the center of rotation with respect to the initial stationery position can cause execution of a user interface input command to wind a coiled spring or reel in a virtual fishing game when a user has just caught a fish with an overhead ‘throw’ motion of the mobile device.

As previously explained some defined types of motions are composite motions. For example, a repeated full circular motion can be used to cause execution of an “erase” user interface input command in an application that offers drawing, sketching and/or painting features. In another example, the same full circular motion can also be used to cause execution in a game of a user interface input command to polish, shine, and buff the paint of a car. It is to be understood that in these circular motion examples there is no rotation of the mobile device and therefore there is no axis of rotation. Instead, the device is being translated along a circular path where x=r cos(t) and y=r sin(t) and (x,y) is the current position at time t, r is within a defined range.

In yet another example, a user moving the mobile device “up, right, down and left” (that is, a linear motion up along the y-axis, followed by a linear motion to the right along the x-axis, followed by a linear motion down along the y-axis, followed by a linear motion to the left along the x-axis) can cause execution of a user interface input command to add a border or frame around a displayed image or to crop or re-size a displayed image.

Similarly some composite motions combine a linear motion with an angular motion. For example, a user moving a mobile device in circles (i.e., a rotational or angular motion about the z-axis) while moving the device away from the user (i.e., a linear motion along the z-axis) can cause execution of a user interface input command to tunnel or bore a hole when the mobile device is in the operating context of a treasure hunt game. Another example is a user moving the mobile device in a circular motion (i.e., a rotational or angular motion about the z-axis) white moving the device down user (i.e., a linear motion along the y-axis) with respect to the initial position to cause execution of a user interface input command of creating turbulence in an AR space (e.g. to simulate a tornado in an AR image when playing a game) when the mobile device is in the operating context of running an AR game.

White any such defined type of motion may be used, in one embodiment these motions are typically either a linear motion, an angular motion or a composite motion (it is to be understood that a composite motion is a combination of more than one linear motion, a combination of more than one angular motion or a combination of at least one linear motion and at least one angular motion) as explained above.

In other embodiments, the defined type of discrete motions can be transformative, deformative, or compound. A transformative motion is defined as a motion that alters the form factor of a mobile device (e.g., sliding a keyboard out from a mobile device to enter text or opening a clamshell-type mobile device to conduct a phone call) whereas a deformative motion is defined as a motion that disfigures or physically alters the size and/or shape of a mobile device in a manner unnecessary for its primary intended use (e.g., stretching or folding a mobile device such as a cell phone where such motion is unnecessary to conduct a phone call). It is to be understood that a compound motion combines one or more deformative or transformative motion with one or more deformative, transformative, linear, angular, or composite motion. Thus, a compound motion can be a combination of more than one transformative motion, a combination of more than one deformative motion, a combination of at least one transformative motion and at least one angular, linear, composite, or deformative motion, or a combination of at least one deformative motion and at least one angular, linear, composite, or transformative motion. While discrete motions contributing to a compound motion are preferably performed sequentially, one of ordinary skill in the art will understand that a user may also perform the discrete motions simultaneously. Some of the transformative, deformative, and compound motions are particularly useful with mobile devices fabricated from flexible materials as such devices can be flexed, folded, wrapped, crumpled, etc. without breaking. One such flexible device is described in U.S. Patent Application No. 2010/0011291 A1, published Jan. 14, 2010, incorporated herein by reference in its entirety.

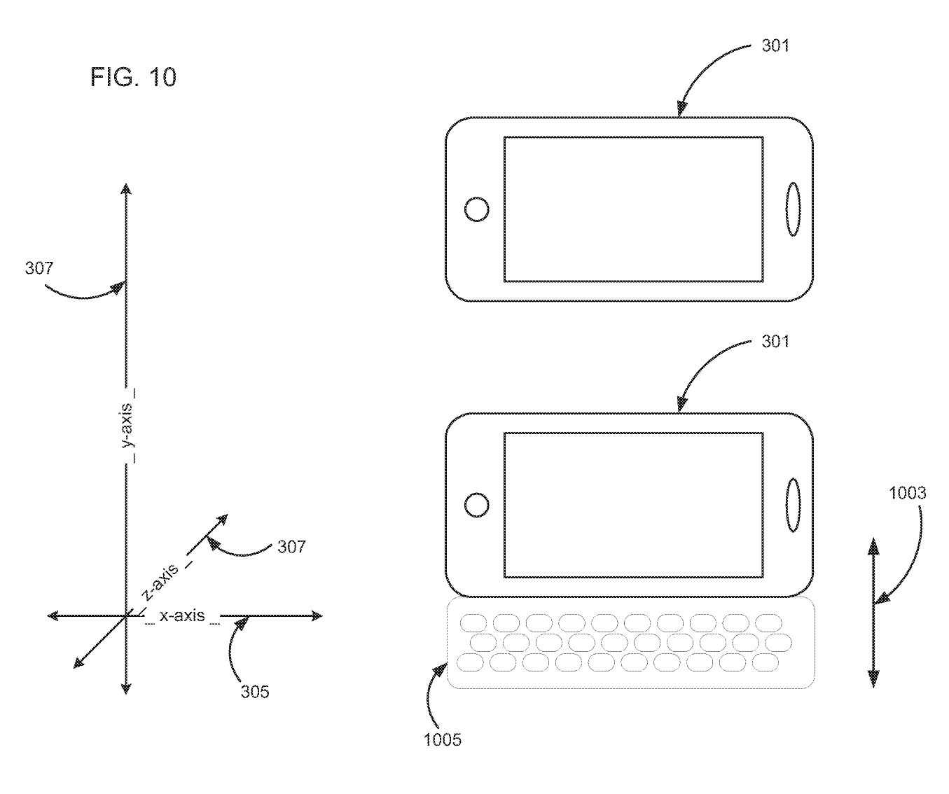

One example of a transformative motion is shown in FIG. 10, Mobile device 301 is shown with respect to the three-dimensional space represented by the three axes (x, y, and z). The initial closed state of mobile device 301 (i.e., mobile device 301 closed as shown in the upper panel of the figure) is transformed as a user slides keyboard 1005 out of the mobile device until mobile device 301 is in an open state (as shown in the lower panel). This transformative motion 1003 can serve, for example, as a select input command to stretch a displayed object, or as a global input command to remove a top layer in a multi-layer AR view (i.e., slide out the top layer from the AR view). Similarly, transforming mobile device 301 by sliding keyboard 1005 back into mobile device 301 can serve, for example, as a select input command to shrink a displayed object, or as a global input command to add a top layer in a multi-layer AR view (i.e., slide in an overlay view).

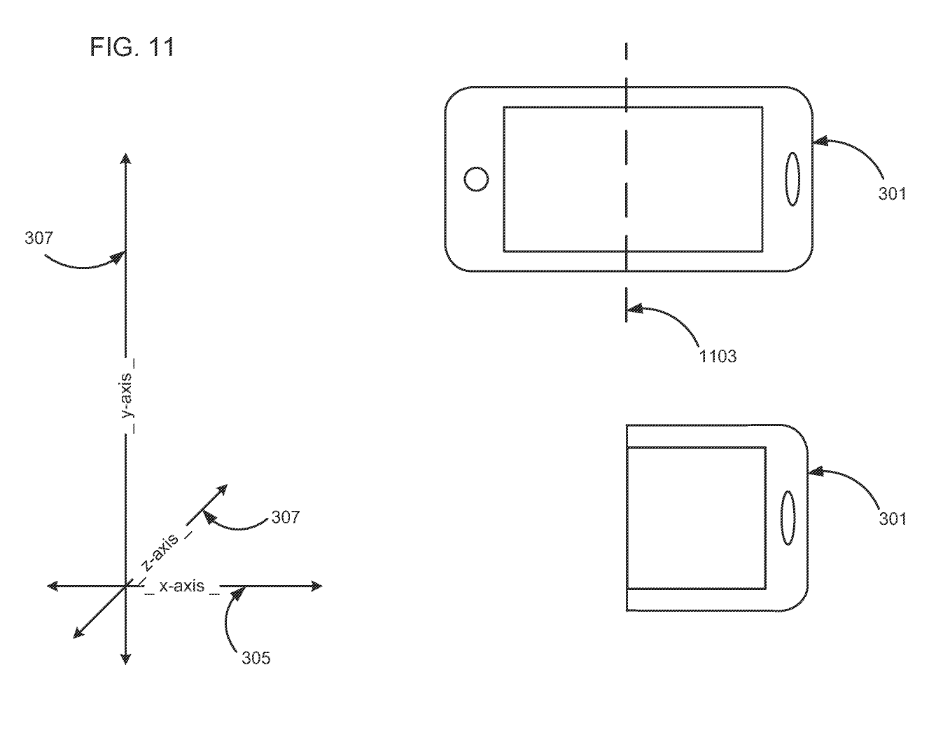

An example of a deformative motion is shown in FIG. 11. The initial physical state of mobile device 301 (upper panel) can be changed by bending (deforming) flexible mobile device 301 around the y-axis 1103 (e.g., bending the left half of mobile device 301 around the y-axis to be behind the right half of mobile device 301 as pictured in the lower panel of the figure) or around the x- or z-axis. Deforming mobile device 301 by folding it can serve, for example, as a select input command to hide a displayed object, or as a global input command to minimize a display view. Deforming mobile device 301 by unfolding it can serve as a select input command to show an object, or as a global command to maximize a display view.

Additional exemplary defined transformational, deformative, and compound motions and the associated user interface input commands that can be executed depending on the operating context of the mobile device are shown in Table 2 (below).

TABLE 2
Examples of Transformative, Deformative, and Compound Motions

| Motion | Command (Select) | Command (Global) |
|---|---|---|
| Transformative motion | Compress object | Slide-in overlay view/list |
| (slide-in keyboard) | | |
| Transformative motion | Stretch object | Slide-out overlay view/list |
| (slide-out keyboard) | | |
| Deformative motion | Grow object | Zoom-in view |
| (stretch) | | |
| Deformative motion | Shrink object | Zoom-out view |
| (compress) | | |
| Deformative motion | Separate or ungroup | Separate or ungroup view(s) |
| (twist) | object(s) | |
| Deformative motion | Hide object | Minimize view |
| (fold-in) | | |
| Deformative motion | Show object | Maximize view |
| (fold-out) | | |
| Deformative motion | Roll-in objects from | Roll-in preview |
| (roll-in) | preview | |
| Deformative motion | Roll-out objects in | Roll-out preview |
| (roll-out) | preview | |
| Deformative motion | Group objects | Group views |
| (crush) | | |
| Quick transformative motion (drop- | Elongate/widen object | Change perspective view |
| down keyboard) | | |
| Repeated transformative motion | Slice/dice object | Cycle perspective views |
| (repeatedly slide-in/slide-out | | |
| keyboard) | | |
| Quick deformative motion | Make object static | Lock all objects in view |
| (clamp device) | | |
| Repeated deformative motion | Sort objects of type | sort all objects in view |
| (repeatedly twist device) | | |
| Compound transformative motions | Add single object to | Group objects/ |
| (Twist and slide-in keyboard) | group | Regroup objects previously |
| | | separated |
| Compound transformative motions | Separate or ungroup last | Separate or ungroup |
| (Slide-out keyboard and twist) | added object | last added view |
| Compound transformative and | Send objects(s) to back | Disable foreground |
| linear motion | | rendering |
| (Slide-in keyboard and Push-out | | |
| device) | | |
| Compound transformative and | Send object(s) to front | Disable background |
| linear motion | | rendering |
| (Slide-out keyboard and Pull-in | | |
| device) | | |
| Compound transformative and | Lock object | Lock view |
| angular motion | | |
| (Twist and Rotate device clockwise) | | |
| Compound transformative and | Unlock object | Unlock view |
| angular motion | | |
| (Twist and Rotate device | | |
| counterclockwise) | | |
| Compound linear, angular, and | Simulate/test object | Bake/Test Level |
| transformative motion | | |
| (rotate device parallel to surface, | | |
| place device on surface, fold or | | |
| crush device into place) | | |

As indicated in Table 2, mobile device 301 can be deformed in a number of other ways that can serve as intuitive input motions to command various actions during AR design. For example, mobile device 301 can be twisted in one direction to separate or ungroup objects or views, and twisted in another direction to group objects or views. Or, mobile device 301 can be stretched to expand an object or to zoom-in on a view and can be compressed to shrink an object or to zoom-out from a view. Mobile device 301 can also be rolled (i.e., rolled-in or rolled-up) to pull-in objects from a preview (or the entire preview) and can be unrolled (i.e., rolled-out) to send objects or views to a preview. As yet another example, mobile device 301 can be crushed to command that objects (or views) be grouped. One of skill in the art will understand that the difference between “compress” and “crush” is a matter of implementation relative to the operating context.

Several compound motions can also serve as intuitive input commands for game-playing, AR design, or other applications. For example, a user can twist and slide-in keyboard 1005 of mobile device 301 as an input command to add a single object to a group, or to group (or regroup) objects previously separated, or slide-out and twist keyboard 1005 to separate or ungroup a last added object or view. Similarly, a user can slide-in keyboard 1005 and push-out mobile device 301 to execute an input command to send an object to the back, and slide-out keyboard 1005 and pull-in mobile device 301 to send an object to the front. Or, objects (or views) can be locked and unlocked by twisting and rotating mobile device 301 clockwise or counter-clockwise, respectively.

Transformative, deformative, and compound motions can be used as input commands because transformative or deformative movements of mobile device 301 are detected by sensors within the mobile device which inform the mobile device when the user starts and stops the motion. As discussed above, mobile device 301 receives position coordinates of the mobile device along the x-axis, y-axis and z-axis through the accelerometer, gyroscope, and/or other sensors of the device, transforms these coordinates to a spherical coordinate system, and calculates net changes in motions along each of the three axes relative to the initial stationary positions.

These sensors detect and measure the acceleration and deceleration of the device to inform the mobile device when the user starts and stops the motion. When the mobile device detects that a motion has started, it can then continue to track changes in the phi, theta, or r coordinates of the device's polar position for changes until it detects that the motion has stopped. If the mobile device calculates a net change registered by one or more sensor which exceeds a set threshold with respect to the initial stationery position, then the system can conclude that the user performed an intentional motion with the device. In a deformable mobile device, flex sensors or bend sensors embedded in the device can be used to sense the bend gesture input recognition. Some flex sensors can incorporate components that change resistance when bent. For example, an unflexed sensor may have a nominal resistance of 10,000 ohms (10 KΩ), but when the flex sensor is bent in either direction, the resistance gradually decreases.

A motion-driven user interface enables an intuitive user interaction with a mobile device to facilitate AR environment customization. The term customization herein refers to user-created or -modified levels in an AR application, as for example, by adding anew level to a game, or by modifying the degree of difficulty of play, Customization can also include creating a new level, adding, deleting, moving, copying, and/or resizing (shrinking, growing, stretching, etc.) one or more selected objects within the AR level or view, and/or scrambling the entire AR level or view. In these embodiments, the input motion is a sequence of discrete motions and the resulting customization/action is based on both the type and extent of the motions. As discussed above, the type of motion may be angular, linear, composite, transformational, deformational, or compound. The extent of the motion may vary, as for example, in duration or intensity of the motion, distance traversed or degree of rotation during the motion. For example, the input command executed in response to sliding-out and twisting a keyboard (a compound motion composed of two discrete transformational motions) may differ based on the degree of rotation of the keyboard (i.e., e.g., how many degrees from a given orientation the keyboard is twisted).

These embodiments operate so as to minimize the learning curve of a new user by utilizing intuitive motions and associating those intuitive motions with certain often-used commands, and provide a much more efficient mechanism for customization of an AR application because a user can interact with the mobile device more readily, e.g., with one hand only (i.e., the hand holding the device) while the other hand is free to do other activities. Motion-driven gestures also spare the user from reading menus with small text on a mobile device with a limited screen size, thus improving the entire user experience. A single motion-drive gesture can effectively replace the several keystrokes necessary to carry out an equivalent command in a menu-based environment, thereby providing a faster method of interaction for customization.

Several essential functions in the development of an AR environment can be triggered using a motion-driven user interface to customize the AR environment. One such essential function is the generation of a random level within an AR environment. When creating a level in a traditional virtual environment, such as in a non-AR video game, the most direct approach to generating a random level is to 1) seed a pseudo-random number generator with some non-deterministic value, such as the time of day, and 2) invoke the pseudo-random number generator to return a pseudo-random value based on this seed and the number of times the generator has been invoked since being seeded. This procedure works because modern pseudo-random number generators are specifically designed to be deterministic so as to return the same sequence of values for a given seed (in this case, time of day), and an infinite number of pseudo-random values can be generated by multiple invocations. Each of these pseudo-random values can then be used for the purpose of arranging virtual objects within the level. The randomization and subsequent virtual arrangement process is typically initiated by clicking or touching a menu item to generate a random level.

A similar approach is typically applied to create a level within a traditional AR environment (such as an AR video game). Virtual objects displayed on the screen and super-imposed over the real world are arranged within the level (e.g., the current room) based upon values generated by a pseudo-random number generator seeded with the time of day. A programmer can also implement a discrete, one-dimensional motion within a GUI (analogous to the touch or click of a menu item) for a user to indicate an intention to generate a random level in this manner. For example, a device can be panned (moved from one side to another) so that a floating AR menu is in view, and the user can then touch the portion of the screen corresponding to the “Generate Random Level” menu item, or can push the device away from himself so that the screen intersects with the floating menu item.

Because true randomness of levels is difficult, if not impossible to achieve without direct input from the user, current AR implementations (typically in a PC in which motion-driven user interfaces have not been actualized) rely on pseudo-random number generators. When random number generation is seeded by user input, the inputs are usually discrete, one-dimensional motions in which the random input is cumbersome and/or conflicts with the general paradigm by which users interact with the GUI.

A more intuitive user interaction can be achieved by utilizing a motion-driven user interface within an AR environment. For example, to generate a random level, a user can simply shake the device by alternatively rotating the device clockwise and counterclockwise and/or by alternatively rotating the device up-and-away and in-and-towards the user (similar to a flick of the wrist). Rather than simply using this composite sequence of angular motions to indicate that a pseudo-random number generator should be seeded with the time of day (and then subsequently invoking it for pseudo-random numbers), a truly random level can be generated by transforming the sequence of inputs from the accelerometer, gyroscope, and/or compass processed for the duration of this initiating motion into the appropriate values to arrange all virtual objects in the augmented reality level.

This more intuitive method of generating a random level reduces intervening steps between initiating a physical action and actualizing a virtual function (e.g., a GUI user must navigate a series of menus to seed and then invoke a pseudo-random number generator, but the intuitive motion-driven interface can be activated by a shaking motion at any time). The intuitive motion-driven interface also allows the user to have a finer degree of control over how much and in what ways a level is randomly generated, since the specific arrangement of virtual objects directly depends upon the duration, intensity, and general style with which the user shakes the device.

Another example of an essential design need for an AR environment is the creation of a walk-mesh. In a non-AR video game, the most direct approach to generating the walk-mesh for a given level is a process called “baking” the level. This baking process is comprised of triangulating a series of polygons across the floor, stairs, etc., of a level while excluding walls, trees, barriers, etc. for the purpose of determining the walkable or traversable areas of a level. The resulting output data structure is often called a “walk-mesh,” and is generated as part of the final preparations of a level before consumption (hence the terminology, because baking the level prepares the level for consumption). As when generating a random level, the most common way to generate the walk-mesh for a given level is to touch (or click or perform a discrete, one-dimensional motion) a “bake level” menu item within a GUI. Level designers then often touch-up or tweak the walk-mesh because mistakes can occur as a result of the automatic generation process. These changes are also made within a GUI which may or may not include isolated motions of a discrete, one-dimensional kind.

A similar approach can be applied to create a level walk-mesh in an AR environment such as in an AR video game. A programmer using known GUI methods can choose to indicate the traversable areas of a level by walking around the level and allowing the application to record the programmer's location using aGPS, accelerometer, gyroscope, and/or compass information, or by using a similar discrete, one-dimensional motion (such as the programmer pushing the device away from himself so as to indicate that the broad area in front of the device and within the view frustum is or is not walkable).

A more intuitive user interaction can be achieved by using a motion-driven user interface with the AR environment. For example, a user can simply perform a “place in oven” motion composed of rotating the device to be parallel with a surface, lowering the device onto that surface, and then closing or otherwise transforming the device as they would an oven. After the baking process is complete, the resulting walk-mesh can be edited using other motions, including continuous, multi-dimensional motions such as circling devices around areas of the walk-mesh which are not traversable or stretching the mesh with a tilted, dragging motion.

Using the motion-driven user interface to generate the walk-mesh for a given level reduces the levels of indirection between initiating a physical action and a virtual function (i.e., a user need not navigate a menu or traverse the whole room to generate a walk-mesh, and the physical action of baking is virtually represented). The motion-driven user interface further allows the user a fine degree of control over how and to what degree the walk-mesh is edited since the specific areas of an AR environment which can be selected as walkable or not walkable are best indicated with a motion-driven user interface by gesturing with compound continuous, multi-dimensional motions rather than with a single, discrete, one-dimensional motion intermixed with touch or click-based inputs within a GUI.

Other AR design examples for which use of a motion-driven user interface is preferable to the use of a contemporary GUI include, without limitation, the placement of directional lighting, the arrangement of conversation nodes within a dialogue tree, the “blocking” or framing of boundaries within a level, or the sculpting of digital objects within a level. In all of these examples, a metaphor for the game design with a physical analog is available and can be incorporated into a motion-driven user interface (but not into a traditional GUI implementations which divorce these physical analogs from the user interface).

It is to be understood that the examples given are for illustrative purposes only (for example the diagrams show the mobile device in a landscape orientation, but the methods are applicable in a portrait orientation as well) and may be extended to other implementations and embodiments with a different set of sensors, defined types of motions, conventions and techniques. While a number of embodiments are described, there is no intent to limit the disclosure to the embodiment(s) disclosed herein. On the contrary, the intent is to cover all alternatives, modifications, and equivalents apparent to those familiar with the art.

Likewise, it is to be understood that although the term game has been used as an example, the techniques and approach described herein are equally applicable to any other piece of software code, application program, operating system or operating context. There is no intent to limit the disclosure to game applications or player applications and the term player and user are considered synonymous as do games and software applications.

It is to be further understood that the mobile device described herein can be any mobile device with a user interface such as a phone, smartphone (such as the iPhone from Apple, Inc., a BlackBerry device from Research in Motion Limited, or a phone running the Android OS from Google, Inc. of Mountain View, Calif.), personal digital assistant (PDA), media device (such as the iPod or iPod Touch from Apple, Inc.), electronic tablet (such as an iPad from Apple, Inc., or the HP Slate from Hewlett-Packard Development Company, L.P.), electronic reader device (such as the Kindle or Kindle DX from Amazon.com, Inc. of Seattle, Wash., or The Reader from SONY Electronics Inc. hand held game console, embedded devices such as electronic toys, etc., that have a processor, memory and display screen, or a flexible mobile device.

Further, while a number of the examples are described as a game running on a mobile device, it is to be understood that the game itself, along with the ancillary functions such as sensor operations, device communications, user input and device display generation, etc., can all be implemented in software stored in a computer readable storage medium for access as needed to either run such software on the appropriate processing hardware of the mobile device.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A motion-driven user interface method for the customization of augmented reality environments comprising:
detecting a sequence of discrete motions of a mobile device using one or more sensors located within the mobile device, each of the discrete motions having a type and an extent;
confirming by a processor of the mobile device that the detected sequence of discrete motions of the mobile device exceeds a preset threshold;
determining by the mobile device processor that the types of the discrete motions in the confirmed detected sequence of discrete motions of the mobile device matches a defined sequence of discrete motions; and
executing by the mobile device processor a motion-driven user interface input-command associated with the defined sequence of discrete motions, wherein the input command customizes an augmented reality environment based on the extent of the discrete motions.

2. The motion-driven user interface method of claim 1 wherein the user interface input command associated with the defined sequence of discrete motions varies depending upon what context in which the motion-driven user interface is operating when the step of detecting sequence of discrete motions of the mobile device occurs.

3. The motion-driven user interface method of claim 1 wherein the one or more sensors comprise at least one sensor from the group comprising a global positioning system, a camera, a compass, a gyroscope and an accelerometer.

4. The motion-driven user interface method of claim 1 wherein the defined sequence of discrete motions comprises at least two deformative motions.

5. The motion-driven user interface method of claim 1 wherein the defined sequence of discrete motions comprises two or more transformative motions.

6. The motion-driven user interface method of claim 1 wherein a type of discrete motion in the defined sequence comprises one or more motion from the group comprising linear, angular, transformative, and deformative motions.

7. The motion-driven user interface method of claim 1 wherein the sequence of discrete motions in the defined sequence comprises one or more composite or compound motion.

8. The motion-driven user interface method of claim 1 wherein the extent of one or more of the discrete motions in the defined sequence of motions is based on the duration of the one or more discrete motion.

9. The motion-driven user interface method of claim 1 wherein the extent of one or more of the discrete motions in the defined sequence of motions is based on the intensity of the one or more discrete motion.

10. The motion-driven user interface method of claim 1 wherein customizing the augmented reality environment generates a random level in the augmented reality environment.

11. The motion-driven user interface method of claim 1 wherein customizing the augmented reality environment generates a walk-mesh for a given level in the augmented reality environment.

12. A non-transitory computer readable medium having stored thereupon a programming code executable by a processor, the programming code configured to perform a motion-driven user interface method for the customization of augmented reality environments, the method comprising:
detecting a sequence of discrete motions of a mobile device using one or more sensors located within the mobile device, each of the discrete motions having a type and an extent;
confirming by a processor of the mobile device that the detected sequence of discrete motions of the mobile device exceeds a preset threshold;
determining by the mobile device processor that the types of the discrete motions in the confirmed detected sequence of discrete motions of the mobile device matches a defined sequence of discrete motions; and
executing by the mobile device processor a motion-driven user interface input-command associated with the defined sequence of discrete motions, wherein the input command customizes an augmented reality environment based on the extent of the discrete motions.

13. The non-transitory computer readable medium of claim 12 wherein the user interface input-command associated with the defined sequence of discrete motions varies depending upon what context in which the mobile device user interface is operating when the step of detecting a sequence of discrete motions of the mobile device occurs.
